(19) United States
(12) Patent Application Publication
(10) Pub. No.: US 2009/0218886 A1
(43) Pub. Date: Sep. 3, 2009

(54) REMOTE ACTUATION BASED ON MEASURING ELECTRIC CURRENT CONSUMPTION

(76) Inventor: Zion Halfon, Herzliya (IL)

Correspondence Address: SMITH FROHWEIN TEMPEL GREENLEE BLAHA, LLC, Two Ravinia Drive, Suite 700, ATLANTA, GA, 30346, US

(21) Appl. No.: 12/394,045

(22) Filed: Feb. 27, 2009

Related U.S. Application Data
(60) Provisional application No. 61/032,432, filed on Feb. 29, 2008.

(51) Int. Cl. H01H 47/32

(52) U.S. Cl. 307/39; 361/187

(57) ABSTRACT

An actuating device containing an electric current relay operative to connect an electric current source with an electric current consumer; an electric current detector operative to measure electric current via an electric conductor connecting said electric current source and said electric current consumer to form current measurement; and a current controller connected with said electric current relay and with said electric current detector, said current controller being operative to control said relay, to receive said current measurement, and to detect a predefined event associated with a state of said current relay and said current measurement.

### CROSS-REFERENCE TO RELATED APPLICATIONS

The present application claims priority from U.S. Provisional Application for Patent filed on Feb. 29, 2008 and assigned Ser. No. 61/032,432, the contents of which are hereby incorporated by reference.

### BACKGROUND

The present invention relates to control systems and, more particularly, but not exclusively to controlling a poultry house using continuous measurements of electric current consumption of various instruments useful therein.

Control systems, such as systems based on a programmable logic controller (PLC) are usually connected to measuring devices on one hand, and, depending on some programmed logic, operate electric devices on the other hand. In many cases several controllers are used, each is operating one electric device or a group of devices. If one of the measuring devices or the controllers, or the operated devices, fails for any reason, or in case of a partial power failure, the controlled environment, such as a poultry house, may develop adverse conditions before anyone notices.

There is thus a widely recognized need for, and it would be highly advantageous to have, a control system devoid of the above limitations.

### BRIEF SUMMARY

According to one aspect of the present invention there is provided an actuating device containing:

an electric current relay operative to connect an electric current source with an electric current consumer;

an electric current detector operative to measure electric current via an electric conductor connecting the electric current source and the electric current consumer to form current measurement; and

a current controller connected with the electric current relay and with the electric current detector, the current controller being operative to control the relay, to receive the current measurement, and to detect a predefined event associated with a state of the current relay and the current measurement.

According to another aspect of the present invention there is provided an actuating device wherein the electric current detector is a three-phase electric current detector; and wherein the electric current relay is a three-phase electric current relay.

According to still another aspect of the present invention there is provided an actuating device wherein the event is determined according to presence of the electric current, and/or level of the electric current, and/or temporal characteristics of the electric current, and/or elapsed time the electric current is present, and/or elapsed time a predefined value of the electric current is measured, and/or elapsed time the electric current is not present, and/or time of change of the state of the current relay, and/or time of the current measurement, and/or relation between the time of change of the state of the current relay and time of the current measurement.

According to yet another aspect of the present invention there is provided an actuating device wherein an external controller controls the electric current source and/or the electric current consumer.

Further according to another aspect of the present invention there is provided an actuating device wherein the event indicates operation of the electric current consumer, and/or inoperability of the electric current consumer, and/or irregular operation of the electric current consumer, and/or state of an external controller.

Yet further according to another aspect of the present invention there is provided an actuating device additionally containing a relay, the relay being controlled by the relay to perform break a contact and make a contact between at least two parts of the electric conductor.

Still further according to another aspect of the present invention there is provided an actuating device additionally containing a memory unit operative to store at least one event detection rule, the event detection rule operative to instruct the controller to detect the predefined event.

Even further according to another aspect of the present invention there is provided an actuating device additionally containing a communication unit operative to communicate the event to an external control system.

Additionally according to another aspect of the present invention there is provided an actuating device additionally containing a master controller communicating with at least one the controller.

Also according to another aspect of the present invention there is provided an actuating device wherein the master controller additionally containing a memory unit operative to store at least one event detection rule, the event detection rule operative to instruct the master controller to detect the predefined event.

Further according to another aspect of the present invention there is provided an actuating device containing a plurality of the electric current relay and a plurality of electric current detectors and wherein the event is associated with a state of a first current relay and a current measurement from an electric current detector associated with a second current relay.

Still further according to another aspect of the present invention there is provided an actuating device containing a plurality of the electric current relay and a plurality of electric current detectors and wherein the event is associated with:

a state of a current relay and a plurality of current measurements from a plurality of electric current detectors;

a state of a plurality of current relays and a current measurement; and

a plurality of states of current relays and current measurements from a plurality of electric current detectors.

Unless otherwise defined, all technical and scientific terms used herein have the same meaning as commonly understood by one of ordinary skill in the art to which this invention belongs. The materials, methods, and examples provided herein are illustrative only and not intended to be limiting. Except to the extend necessary or inherent in the processes themselves, no particular order to steps or stages of methods and processes described in this disclosure, including the figures, is intended or implied.

In many cases the order of process steps may varied without changing the purpose or effect of the methods described.

Implementation of the method and system of the present invention involves performing or completing certain selected tasks or steps manually, automatically, or any combination thereof. Moreover, according to actual instrumentation and equipment of preferred embodiments of the method and system of the present invention, several selected steps could be implemented by hardware or by software on any operating system of any firmware or any combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE SEVERAL VIEWS OF THE DRAWING

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified block diagram of a remote controller unit containing contains a relay, a current sensor and a micro-controller;

FIG. 2 is a simplified block diagram of the micro-controller of FIG. 1;

FIG. 3 is a simplified block diagram of a remote control system containing a remote controller unit similar to the remote controller unit of FIG. 1;

FIG. 4 is a simplified flow chart of software program executed by the remote controller unit of FIG. 3; and

FIG. 5 is a simplified flow chart of an alternative software program executed by the remote controller unit of FIG. 3.

### DETAILED DESCRIPTION OF EMBODIMENTS OF THE INVENTION

The present embodiments comprise a control device operative to supply operating electric power to an operated electric device, to measure the electric current drawn by the operated electric device, and, according to programmed logic (rules) to cease the operating electric power and/or to communicate the information to another controller. The control device may also use information received from another controller to determine the required action.

The principles and operation of a control device according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

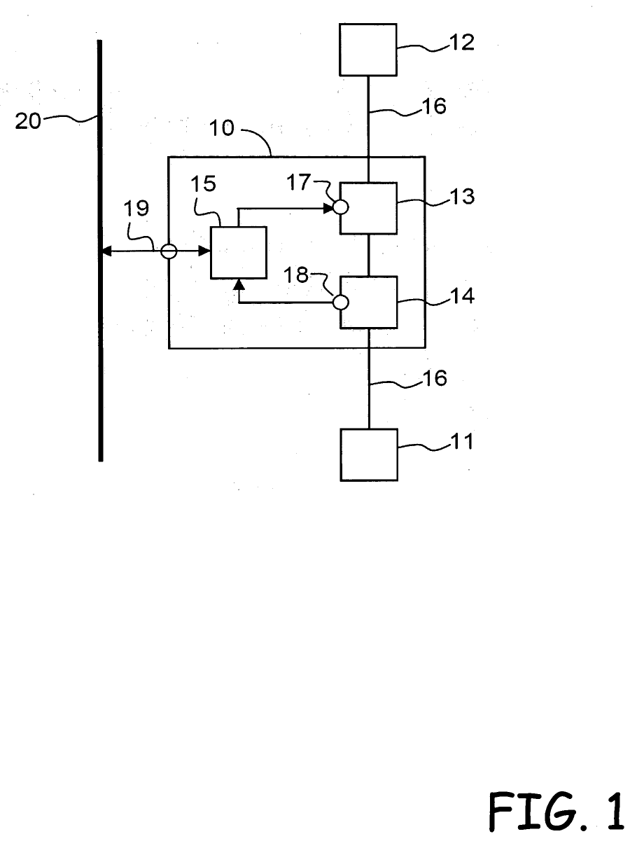

Reference is now made to FIG. 1, which is a simplified block diagram of a remote controller unit 10 according to a preferred embodiment of the present invention. The remote controller unit 10 preferably controls the operation of a device 11 by controlling the supply of electric power to the device 11, preferably by connecting or disconnecting the electric current from an electric power supply 12. Preferably, the electric power supply 12 and the device 11 are not parts of the remote controller unit 10, however, in an alternative embodiment, the electric power supply 12, the device 11 and the remote controller unit 10 are integrated into a single system.

It is appreciated that the electric power supply 12 can include, or connect to, another remote controller (not shown in FIG. 1) for controlling the operation of the device 11, preferably by controlling the power supply to the device 11.

As seen in FIG. 1, the remote controller unit 10 preferably contains a relay 13, a current sensor 14 and a micro-controller 15. The relay 13 is preferably operative to connect and to disconnect electric current in an electric conductor 16 supplying current from the electric power supply 12 to the controlled device 11. Preferably, the relay 13 connects or disconnects the electric current in accordance with a control signal supplied to its terminators (connectors) 17.

The current sensor 14 is preferably operative to measure the current flowing through the conductor 16. Preferably, the current sensor 14 provides the current measurement via its terminators (connector) 18.

The micro-controller 15 is preferably operative to receive the current measurements from the current sensor 14 via connector 18 and to operate the relay 13 to connect or to disconnect the electric current to the device 11 by sending a control signal via connector 17. The micro-controller 15 preferably contains a data link 19 that connects to a communication medium 20. The communication medium 20 can use any kind of communication technology such as a communication bus, a serial data link such as USB, a wireless communication technology such as WiFi or Zigbee, power line carrier (PLC) technology, etc. The communication medium 20 preferably connects several micro-controllers 15.

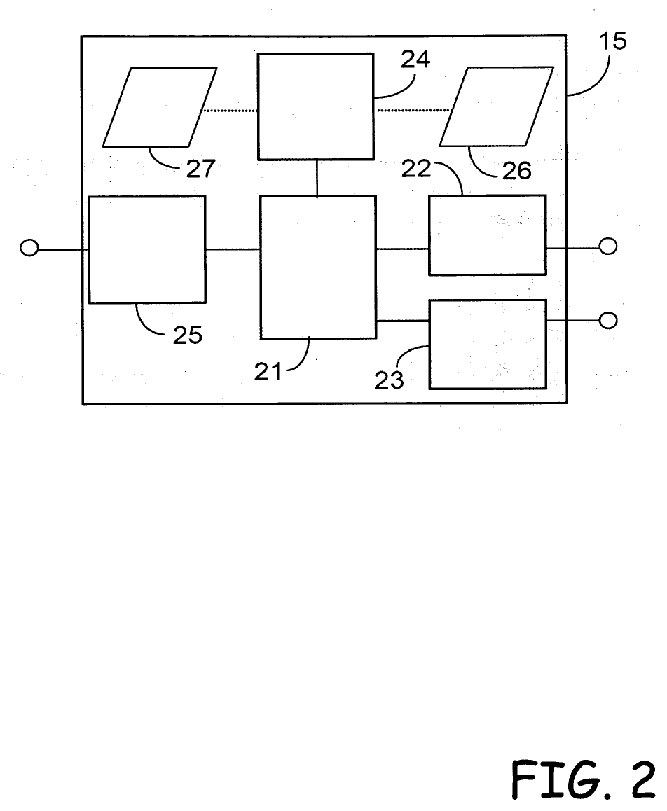

Reference is now made to FIG. 2, which is a simplified block diagram of the micro-controller 15 according to a preferred embodiment of the present invention.

As seen in FIG. 2 the micro-controller 15 preferably includes a processor 21 connected via an output interface 22 to the relay 13, and via an input interface 23 to the current sensor 14. The relay 13 and the current sensor 14 are shown in FIG. 1, and not shown in FIG. 2. The processor 21 also preferably connects to a memory 24 and via a data link interface 25 to data link 20 (shown in FIG. 1 and not shown in FIG. 2). Memory 24 preferably contains software program 26 and rules 27.

The software program 26 is preferably operative to provide instructions to the processor 21 to process the decision rules 27. The micro-controller 15 is preferably operative to process the software program and accordingly perform the following actions:
Receive information from other micro-controllers 15 via the communication medium 20 and data link interface 25;
Receive current measurements from the current sensor 14 via input interface 23;
Determine, and accordingly instruct the relay 13, via output interface 22, to connect or to disconnect the electric current in the conductor 16; and
Determine, and accordingly transmit information via the data link interface 25 and the communication medium 20.

The micro-controller 15 preferably uses the decision rules to determine the instructions to the relay 13 and/or the information to send via the communication medium 20. The information sent via the communication medium 20 is typically the state of the switch (connected or disconnected), current measurement, elapsed time associated with current measurement, etc.

It is appreciated that the micro-controller 15 can be preferably implemented as an integrated circuit.

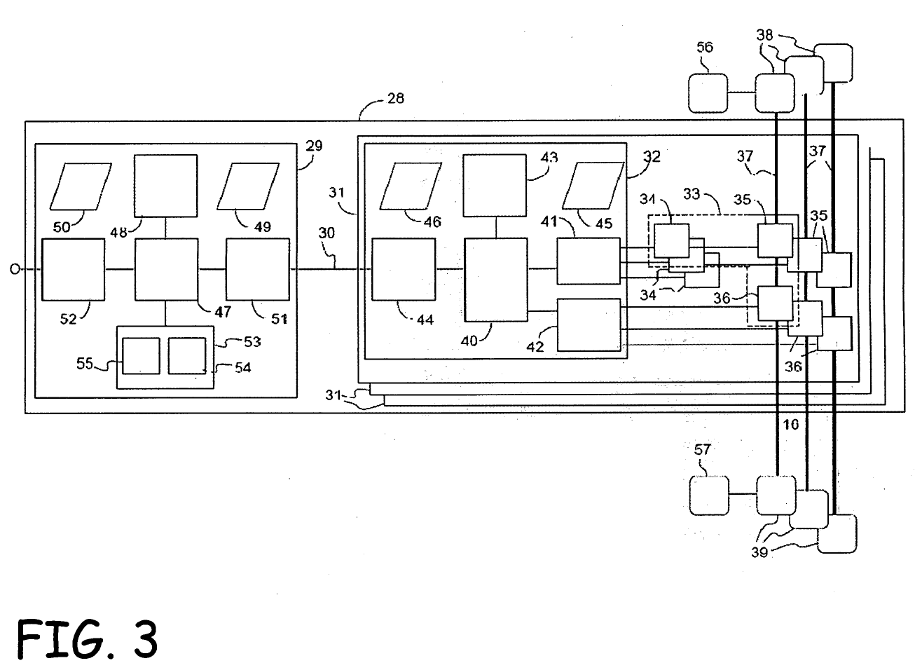

Reference is now made to FIG. 3, which is a simplified block diagram of a remote control system 28 according to a preferred embodiment of the present invention.

As seen in FIG. 3, the remote control system 28 preferably includes a master controller 29 connected preferably via a data link 30 to one or more slave controllers 31. Data link 30 is preferably a digital communication link, preferably similar to the data link 19 or the communication medium 20 of FIG. 1.

As seen in FIG. 3, the salve controller 31 preferably includes a control module 32, preferably controlling one or more sets 33 of a switch 34, a relay 35 and a current sensor 36. The relay 35 is operative to connect or disconnect electric current via conductor 37 connecting a power supply 38 and a device 39. The current sensor 36 measures the electric current through the conductor 37. As an example of a preferred embodiment of the present invention the controller module 32 of FIG. 3 controls three sets 33.

The controller module 32 preferably includes a processor 40 connected via an output interface 41 to the switches 34 and via an input interface 42 to the current sensors 36. The processor 40 also preferably connects to a memory 43 and via a data link interface 44 to data link 30. Memory 43 preferably contains software program 45 and rules 46.

The master controller 29 preferably contains:
a processor 47
a memory 48 connected to the processor 47, preferably containing software program 49 and rules 50;
a data link interface 51 connecting the processor 47 to data link 30;
a data link interface 52 connecting the processor 47 to an external computing equipment;
a user interface 53, preferably containing user-input interface 54 and user output interface 55.

It is appreciated that the operation of the devices 39 can also be controlled by external controllers 56 or 57.

It is appreciated that remote controller unit 10 of FIG. 1, or the remote control system 28 of FIG. 3 operate as an actuating device operative to actuate a remote device which is an electric current consumer. As described above the actuating device includes an electric current relay operative to connect an electric current source with the electric current consumer, and an electric current detector operative to measure electric current via an electric conductor connecting the electric current source and the electric current consumer. The actuating device also includes a processor or a micro-controller operative as a current controller and connected with the electric current relay and with the electric current detector. The current controller is operative to receive current measurements, to detect a predefined event associated with a state of the current relay and with the current measurement, and to control the relay according to a rule associated with the state of the current relay and with the current measurement.

Preferably, the actuating device also contains a relay operative to break and/or to make a contact between parts of said electric conductor connecting the power supply (electric current source) and the consumer device (electric current consumer).

The actuating device can be a single phase actuating device or a three-phase electric current detector. In this respect either or both the current sensor and the current relay can be single phase or three-phase devices.

Preferably, the actuating device can determine events according to either of:
the presence of an electric current via the conductor connecting the power supply and the consumer device;
the level of the electric current;
temporal characteristics of said electric current, such as fluctuations, frequency of peaks or depressions, average values, etc.
elapsed time that the electric current is present;
elapsed time at which a predefined value of the electric current is detected;
elapsed time at which the electric current is not present, or is below a predetermined value;
time of change of the state of the current relay;
time of at which the current is measured;
the relation between the time of change of the state of the current relay and time of the current measurement;
etc.

It is appreciated that the actuating device can use any combination of the above examples to determine an event.

Preferably, the actuating device can measure and control the current to the consumer device even when an external controller (such as controller 56 or 57 of FIG. 3) also control the electric current source or the electric current consumer. It is appreciated that the actuating device preferably supervises the external controller.

Preferably, the actuating device determines events that indicate any of:
the operation of the electric current consumer;
the inoperability of the electric current consumer;
an irregular operation of the electric current consumer;
the state of the external controller.

Preferably, the actuating device detects an event according to event detection rules stored in a memory unit of the actuating device, and to connect or disconnect the current between the power supply and the consumer device according to control rules also stored in the memory of the actuating device.

Preferably, the actuating device also communicates the events to an external control system via a communication unit and a communication medium that can be wired or wireless.

Preferably, the actuating device contains a master controller controlling slave controllers wherein each slave controller functions as an actuating device. The master controller preferably contains a memory unit storing event detection rules and/or control rules. The event detection rules are operative to instruct the master controller to detect said predefined event and the control rules are operative to instruct the master controller to instruct a slave controller to connect or to disconnect the current to a consumer device. It is appreciated that the slave controller can accept such instructions from the master controller, or from another slave controller or from another actuating device. It is also appreciated that the actuating device or the slave controller can accept an event from the master controller, or from another slave controller or from another actuating device and process a control rule associated with that event.

Preferably, the actuating device contains and/or controls a plurality of electric current relays and a plurality of electric current detectors. In such case, event detection rules and/or control rules can be associated with the states a plurality of current relays and/or current measurements from a plurality of electric current detectors.

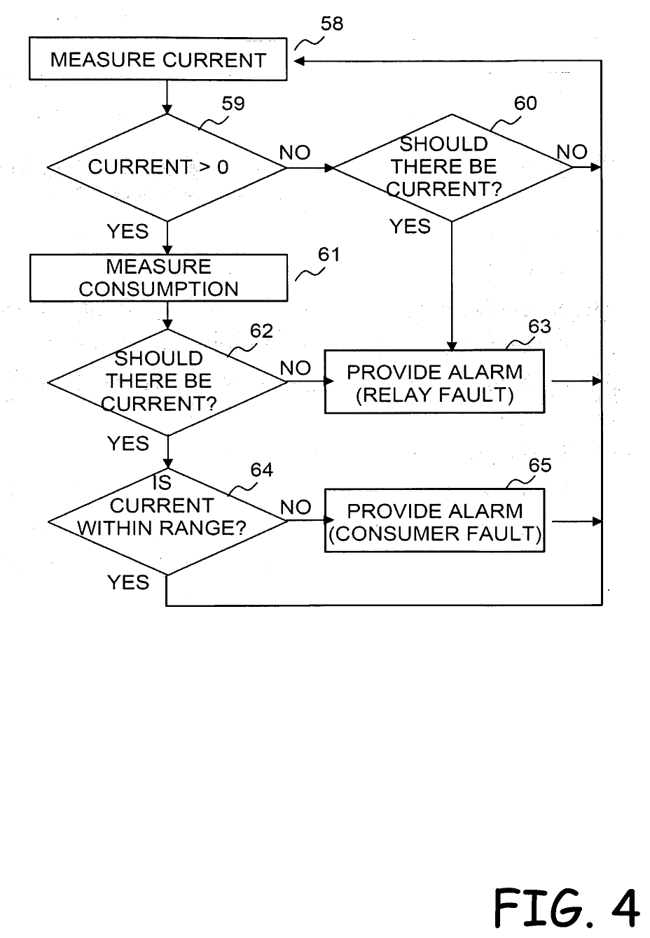

Reference is now made to FIG. 4, which is a simplified flow chart of software program 45 according to a preferred embodiment of the present invention.

As seen in FIG. 4, software program 45 starts with step 58 preferably by measuring electric current. Software program 45 preferably proceeds to steps 59 and 60 to evaluate the current measurement. If no current is measured and no current is expected software program 45 continues measuring the current until either a current is measured or current is expected. If current is measured, software program 45 preferably proceeds to step 61 to measure consumption.

Consumption in this case typically refers to executed work such as heating, rolling a conveyor belt, for example to supply food, etc. Consumption is typically measured by measuring the time current is present. Alternatively, the value of the current measurement is integrated over time to calculate work and estimate the quantity of the relevant consumption.

Software program 45 preferably proceeds to step 62 to evaluate again if current is expected. For example, for supplying food or for supplying heat current is expected for a predetermined maximal period and then should stop. If, at step 62 or at step 60, current is still measured, then software program 45 preferably proceeds to step 63 to provide an alarm, typically indicating a relay fault.

If current is still expected, for example if the supply period did not yet elapse, software program 45 preferably proceeds to step 64 to evaluate if the measured current is within a predefined permitted range. If the measured current is not within the permitted range software program 45 preferably proceeds to step 65 to provide an alarm, preferably indicating a faulty consumer. For example, an over heating heater.

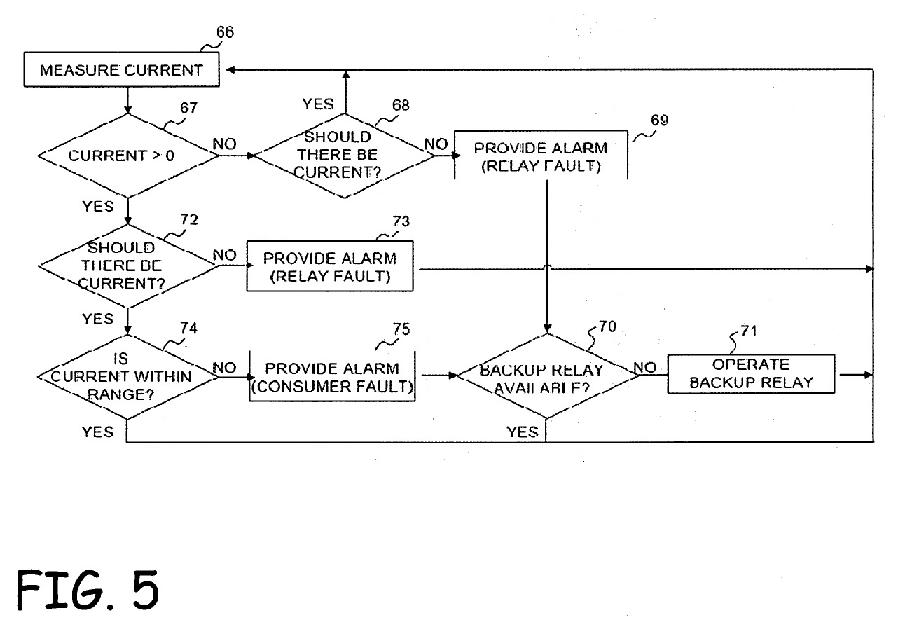

Reference is now made to FIG. 5, which is a simplified flow chart of software program 45 according to an alternative preferred embodiment of the present invention.

As seen in FIG. 5, software program 45 starts with step 66 preferably by measuring electric current. Software program 45 preferably proceeds to steps 67 and 68 to evaluate the current measurement. If no current is measured and no current is expected software program 45 continues measuring the current until either a current is measured or current is expected. If no current is measured, software program 45 preferably proceeds to step 69 to provide an alarm, typically indicating a relay fault. Software program 45 preferably proceeds to step 70 to check whether a backup relay is available. If a backup relay is available, software program 45 preferably proceeds to step 71 to operate the backup relay.

If current is measured when there should be no current (step 72), software program 45 preferably proceeds to step 73 to provide an alarm, typically indicating a relay fault.

If current is expected and measured, software program 45 preferably proceeds to step 74 to evaluate if the measured current is within a predefined permitted range. If the measured current is not within the permitted range software program 45 preferably proceeds to step 75 to provide an alarm, preferably indicating a faulty consumer. For example, an over heating heater. Software program 45 then preferably proceeds to steps 70 and 71 to operate a backup relay if such is available.

It is appreciated that the software program 49 can be implemented in a similar manner to the software program 45 as described in accordance to FIGS. 4 and 5.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. An actuating device comprising:
an electric current relay operative to connect an electric current source with an electric current consumer;
an electric current detector operative to measure electric current via an electric conductor connecting said electric current source and said electric current consumer to form current measurement; and
a current controller connected with said electric current relay and with said electric current detector, said current controller being operative to control said relay, to receive said current measurement, and to detect a predefined event associated with a state of said current relay and said current measurement.

2. An actuating device according to claim 1 wherein at least one of
said electric current detector is a three-phase electric current detector; and
said electric current relay is a three-phase electric current relay.

3. An actuating device according to claim 1 wherein said event is determined according to at least one of:
presence of said electric current;
level of said electric current;
temporal characteristics of said electric current;
elapsed time said electric current is present;
elapsed time a predefined value of said electric current is measured;
elapsed time said electric current is not present;
time of change of said state of said current relay;
time of said current measurement; and
relation between said time of change of said state of said current relay and time of said current measurement.

4. An actuating device according to claim 1 wherein an external controller controls (affects the operation of) at least one of:
said electric current source; and
said electric current consumer.

5. An actuating device according to claim 1 wherein said event indicates at least one of:
operation of said electric current consumer;
inoperability of said electric current consumer;
irregular operation of said electric current consumer;
state of an external controller.

6. An actuating device according to claim 1 additionally comprising a relay, said relay being controlled by said relay to perform at least one of break a contact and make a contact between at least two parts of said electric conductor.

7. An actuating device according to claim 1 additionally comprising a memory unit operative to store at least one event detection rule, said event detection rule operative to instruct said controller to detect said predefined event.

8. An actuating device according to claim 1 additionally comprising a communication unit operative to communicate said event to an external control system.

9. An actuating device according to claim 1 additionally comprising a master controller communicating with at least one said controller.

10. An actuating device according to claim 9 wherein said master controller additionally comprising a memory unit operative to store at least one event detection rule, said event detection rule operative to instruct said master controller to detect said predefined event.

11. An actuating device according to claim 1 comprising a plurality of said electric current relay and a plurality of electric current detectors and wherein said event is associated with a state of a first current relay and a current measurement from an electric current detector associated with a second current relay.

12. An actuating device according to claim 1 comprising a plurality of said electric current relay and a plurality of electric current detectors and wherein said event is associated with at least one of:
a state of a current relay and a plurality of current measurements from a plurality of electric current detectors;
a state of a plurality of current relays and a current measurement; and
a plurality of states of current relays and current measurements from a plurality of electric current detectors.
